(19) United States
(12) Patent Application Publication
(10) Pub. No.: US 2015/0288111 A1
(43) Pub. Date: Oct. 8, 2015

(54) PROTECTIVE COVER FOR A POWER ADAPTER

(71) Applicants: Leon C. Spencer, Dallas, GA (US); Robert John Draper, JR., Roswell, GA (US)

(72) Inventors: Leon C. Spencer, Dallas, GA (US); Robert John Draper, JR., Roswell, GA (US)

(21) Appl. No.: 14/244,799

(22) Filed: Apr. 3, 2014

(51) Int. Cl. H01R 13/72; B65D 59/06; B65D 25/24

(52) U.S. Cl. CPC H01R 13/72; B65D 25/24; B65D 59/06

(57) ABSTRACT

An apparatus comprises a cover unit comprising dimensions for encasing an adapter block of a power adapter. The cover unit further comprises at least a first opening being configured for passage of input power to the adapter block, a second opening being configured for passage of output power from the adapter block, and a plurality of ventilation openings for passage of air to and from the adapter block. A plurality of foot structures are disposed on at least a bottom side of the cover unit. The plurality of foot structures are configured for supporting the cover unit a distance above a flat surface.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to power supplies for electronics. More particularly, the invention relates to a protective cover for a power adapter.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Laptop computers, tablet computers, and various other types of electronics are typically powered by an internal rechargeable battery along with an external power adapter. These power adaptors often comprise a cord that plugs into the device and an adapter block that plugs into a wall outlet or that comprises an attached cord that plugs into a wall outlet. A non-limiting example of an external power adapter is an Apple MagSafe® Adapter. The adapter blocks in some power adapters may be around 9.0 oz. to 11 oz. in weight, and in some cases, typically depending on the wattage of the battery, may weigh more. Therefore, it is believed that dropping these adapter blocks may cause damage to the adapter. Furthermore, some adapter blocks may have a smooth exterior, which may lead to instability of the blocks when placed on a surface. One can expect that movement of the adapter block due to any instability may result in added pressure on the wires or cords, which may also cause damage. It is also believed that the wires and cords in some adapters may fray easily from kinking and bending during storage and transport. Moreover, after some usage, the adapter block in many power adapters may become hot to the touch.

By way of educational background, an aspect of the prior art generally useful to be aware of is that external protective covers are currently available to protect some devices from impact such as, but not limited to, phones, laptops, tablet computers, and MP3 players. In addition there are some products on the market that incorporate a cord wrapping mechanism into the adapter, yet typically do not provide protection to the adapter itself.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A through 1C illustrate an exemplary protective cover for an adapter block of a power adapter, in accordance with an embodiment of the present invention. FIG. 1A is a side perspective view of the cover in an exemplary configuration for storage or transport. FIG. 1B is a side perspective view of the cover in a configuration that allows for use of the adapter block, and FIG. 1C is a side perspective view of an alternate configuration for storage or transport;

FIG. 2 is a diagrammatic side view of an exemplary cover on an adapter block, in accordance with an embodiment of the present invention;

FIG. 3 is a side perspective view of an exemplary cover for an adapter block, in accordance with an embodiment of the present invention; and

FIG. 4 is a side perspective view of an exemplary cover for an adapter block, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

One embodiment of the present invention may provide a protective cover for an adapter block of a power adapter. In some embodiments this protective cover may provide protection against drops, dirt, external damage, etc. Moreover, some embodiments may protect users against heat when picking up the adapter block as the adapter block may become hot after a prolonged period of usage. In some embodiments the cover may not only act as a protective case, but may also act as a cradle to hold the adapter block in place. Additionally, some embodiments may incorporate a cord wrap feature to help protect the cords and wires attached to the adapter.

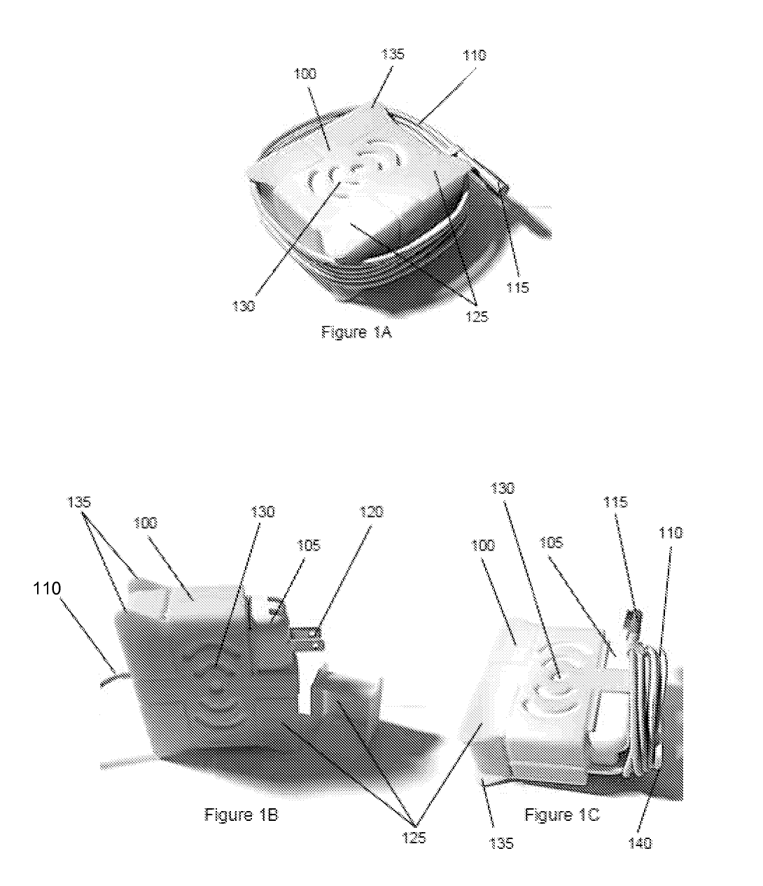

FIGS. 1A through 1C illustrate an exemplary protective cover 100 for an adapter block 105 of a power adapter, in accordance with an embodiment of the present invention. FIG. 1A is a side perspective view of cover 100 in an exemplary configuration for storage or transport. FIG. 1B is a side perspective view of cover 100 in a configuration that allows for use of the adapter, and FIG. 1C is a side perspective view of an alternate configuration for storage or transport. In the present embodiment, adapter block 105 is shown as an Apple MagSafe® adapter and comprises a cord 110 that may be connected to an electronic device by a connector 115 and prongs 120 that may be inserted into a conventional power outlet. Those skilled in the art will readily recognize, in light of and in accordance with the teachings of the present invention, that some alternate embodiments may be configured for various different types of power adapters with various different shapes and comprising various different features. For example, without limitation, some embodiments may be implemented for rectangular or round adapter blocks. Other embodiments may be implemented for power adapters that comprise adapter blocks with a cord ending in prongs to connect to a power outlet rather than prongs protruding directly from the adapter block. In the present embodiment, cover 100 may be made of a multiplicity of suitable materials including, without limitation, plastics, rubber, silicone, etc.

In the present embodiment, cover 100 comprises a removable cap 125 at each corner and openings 130 for ventilation. Caps 125 may be removed to provide openings through which prongs 120 on adapter block 105 may extend. It is contemplated that various different portions of the adapter block such as, but not limited to cord 110 may extend through the openings created when caps 125 are removed. Moreover, one or more openings may be provided specifically for cords in some embodiments. Furthermore, some embodiments may comprise more or fewer removable caps. In the present embodiment, caps 125 comprise tabs 135. Referring to FIG. 1A, tabs 135 may be used to hold cord 110 in place when wrapped around cover 100. In addition, referring to FIG. 1B, when cover 100 is stood upright, tabs 135 may hold adapter block 105 in a position that is elevated off of the surface on which block 105 is resting, which can aid in cooling adapter block 105 by typically enabling air to circulate around all sides of block 105. Openings 130 may also aid in cooling adapter block 105 by typically allowing heat to escape cover 100. It is contemplated that some embodiments may comprise a multiplicity of suitable means for elevating the adapter block such as, but not limited to, pegs, feet, grooves, etc. Other embodiments may be implemented without means for elevation. Referring to FIG. 1C in the present embodiment, cover 100 comprises a cord wrap 140 that may be exposed by removing two caps 125 on one side of cover 100. Referring to FIG. 1A, cord 110 may be wrapped about the periphery of cover 100 with tabs 135 holding wrapped cord 110 from slipping off of cover 100. In this configuration fraying of cord 110 may be minimized by minimizing a pressure on cord 110, as compared to other typical cord wrapping or bundling configurations. Those skilled in the art will readily recognize, in light of and in accordance with the teachings of the present invention, that a multiplicity of suitable means for providing a cord wrap may be used in some alternate embodiments. For example, without limitation, the cord wrap may extend from the outer surface of the cover so that the cord may be wrapped without removing any of the caps, or the cover may comprise grooves into which the cord may be placed. Furthermore, some embodiments may be implemented without a cord wrap.

In typical use of the present embodiment, cover 100 may be placed over adapter block 105 to help protect adapter block 105 from scratches, drops, dirt, etc. Cover 100 may also provide added stability to adapter block 105 by covering block 105 with a non-slip material that typically does not slide easily on a flat surface such as, but not limited to, silicon, rubber, or plastic. After some usage adapter block 105 may get hot, and cover 100 may protect a user's hand from this heat when handling adapter block 105. In addition ventilation openings 130 and elevating tabs 135 may assist in allowing air to circulate around adapter block 105 and dissipate heat. Cover 100 is typically easy to install since cover 100 may be made from a flexible material. Cover 100 may comprise a single piece that slides over adapter block 105 or may comprise two halves that may be placed on each side of block 105 and snapped in place around block 105. Cover 100 typically fits snugly around adapter block 105 and typically allows for full utilization of adapter block 105 and its accessories. Once cover 100 is in place, a user may add or remove the desired caps 125 to access various different portions of adapter block 105. For example, without limitation, the user may remove cap 125 over prongs 120 so that adapter block 105 may be plugged into an outlet to provide power to a device connected to connector 115 at the end of cord 110. When the power adapter is not in use, cord 110 may be wrapped around cord wrap 140 to aid in protecting cord 110 from kinking, bending, fraying, or breaking as illustrated by way of example in FIG. 1C. Alternatively, cord 110 may be wrapped around cover 100 as illustrated by way of example in FIG. 1A.

One may expect that cover 100 may be low in cost to manufacture and therefore inexpensive to buy. In some embodiments the cover may cosmetically enhance the look of an adapter block by adding color or design to the surface of the block. In some embodiments the ventilation openings may have decorative shapes such as, but not limited to, polka dots, hearts, stars, stripes, etc. Other embodiments may be implemented with a wide variety of colorful designs such as, but not limited to, geometric designs, drawings, photographs, etc. Some embodiments may also comprise various different types of embellishments including, but not limited to, rhinestones, metal studs, crystals, embossed designs, etc.

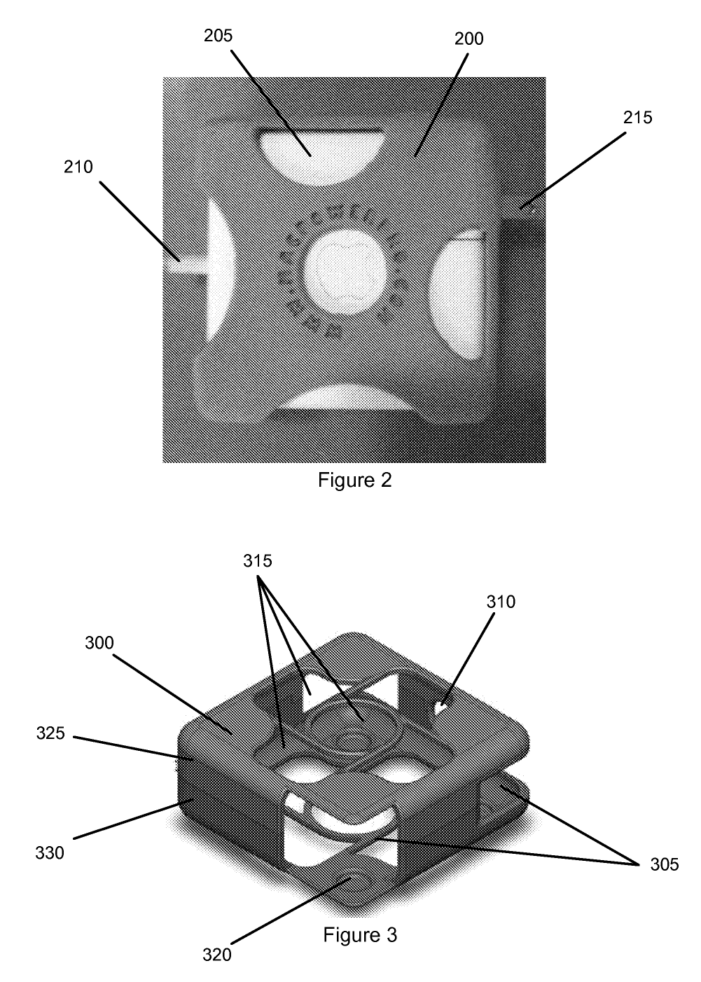

Those skilled in the art will readily recognize, in light of and in accordance with the teachings of the present invention, that a multiplicity of suitable configurations may be used to provide a protective cover for a power adapter in some alternate embodiments. For example, without limitation, some embodiments may be implemented without elevation means or a cord wrap. Other embodiments may be implemented with various different additional features such as, but not limited to, straps made of elastic or hook and loop material for securing cords or other items to the adapter block, means for attaching the cover to a backpack or briefcase, suction cups for added stability when sitting on a surface, etc. Some variations are shown by way of example in FIGS. 2 through 4.

FIG. 2 is a diagrammatic side view of an exemplary cover 200 on an adapter block 205, in accordance with an embodiment of the present invention. In the present embodiment, cover 200 comprises multiple openings to typically enable a cord 210 and prongs 215 to protrude from cover 200. In the present embodiment cover 200 may comprise a one piece construction of a flexible material such as, but not limited to, a silicone or rubber material that may be stretched to fit over adapter block 205. The flexible material may also have a non-slip characteristic to minimize slippage on a hard flat surface such as, but not limited to, a table or desk, which may prevent adapter block 205 from falling to a floor and pulling on cord 210 attached to a device.

FIG. 3 is a side perspective view of an exemplary cover 300 for an adapter block, in accordance with an embodiment of the present invention. In the present embodiment, cover 300 comprises three corners 305 that are open to allow for accessibility to portions of an adapter block inside cover 300 and a cord opening 310. Ventilation openings 315 may be located on the sides of cover 300. In addition, feet 320 may extend from a side of cover 300 to aid in providing air circulation when an adapter block within cover 300 is placed on its side. Cover 300 comprises a left side 325 and a right side 330 that may be separated from each other and snapped in place around an adapter block for installation.

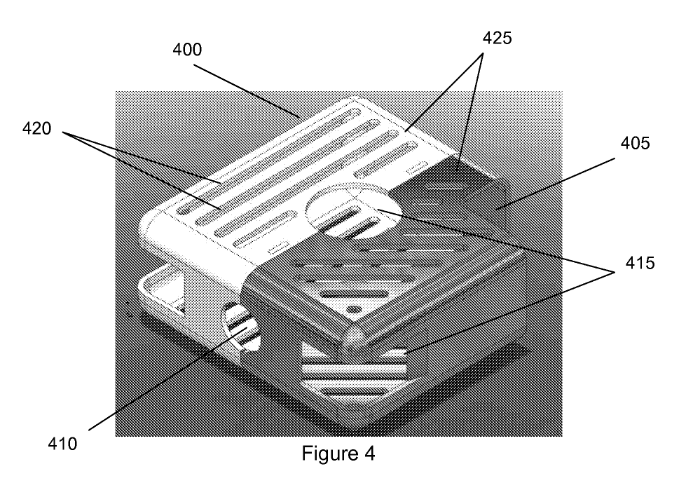

FIG. 4 is a side perspective view of an exemplary cover 400 for an adapter block, in accordance with an embodiment of the present invention. In the present embodiment, cover 400 comprises a notched corner 405 through which the prongs of an adapter block may protrude and a cord opening 410. Additional openings 415 may provide access to various different portions of an enclosed adapter block, and ventilation slots 420 may allow heat to escape cover 400. Cover 400 comprises two halves 425 that may be slid onto an adapter block from each side and snapped into place for installation.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a protective cover for a power adapter according to the present invention will be apparent to those skilled in the art. Various aspects of the invention have been described above by way of illustration, and the specific embodiments disclosed are not intended to limit the invention to the particular forms disclosed. The particular implementation of the protective cover may vary depending upon the particular context or application. By way of example, and not limitation, the protective covers described in the foregoing were principally directed to power adapter protecting implementations; however, similar techniques may instead be applied to protect a multiplicity of suitable devices such as, but not limited to, batteries for electronics, external hard drives, external speakers, webcams, and mice, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus comprising:
a cover unit comprising dimensions for encasing an adapter block of a power adapter, said cover unit further comprising at least a first opening being configured for passage of input power to the adapter block, a second opening being configured for passage of output power from the adapter block, and a plurality of ventilation openings for passage of air to and from the adapter block; and
a plurality of foot structures being disposed on at least a bottom side of said cover unit, said plurality of foot structures being configured for supporting said cover unit a distance above a flat surface.

2. The apparatus as recited in claim 1, further comprising a plurality of tabs being disposed about a periphery of said cover unit, said plurality of tabs being configured for holding a power cord of the power adapter wrapped about said periphery.

3. The apparatus as recited in claim 2, further comprising a plurality of removable caps being configured for exposing passages into said cover unit.

4. The apparatus as recited in claim 3, in which said plurality of tabs are in engagement with said plurality of removable caps.

5. The apparatus as recited in claim 4, in which said plurality of tabs are configured to be further operable for supporting said cover unit in an upright position.

6. The apparatus as recited in claim 1, in which said cover unit further comprises two halves being configured to be removably joinable about the adapter block.

7. The apparatus as recited in claim 5, in which said cover unit further comprises a generally rectangular shape.

8. The apparatus as recited in claim 7, in which said plurality of removable caps engage corners of said rectangular shape.

9. The apparatus as recited in claim 1, in which said plurality of ventilation openings comprise slots.

10. The apparatus as recited in claim 1, in which said cover unit further comprises a non-slip material.

11. The apparatus as recited in claim 1, in which said cover unit further comprises dimensions for snuggly encasing an adapter block of an Apple MagSafe® power adapter.

12. An apparatus comprising:
means for encasing an adapter block of a power adapter, said means being configured for passage of input and output power to the adapter block, and for passage of air to and from the adapter block; and
means for supporting said encasing means a distance above a flat surface.

13. The apparatus as recited in claim 12, further comprising means for holding a power cord of the power adapter wrapped about a periphery of said encasing means.

14. The apparatus as recited in claim 12, further comprising means for exposing passages into said encasing means.

15. An apparatus comprising:
a cover unit comprising a generally rectangular shape having dimensions for snuggly encasing an adapter block of an Apple MagSafe® power adapter, said cover unit further comprising at least a first opening being configured for passage of input power to the adapter block, a second opening being configured for passage of output power from the adapter block, and a plurality of ventilation openings for passage of air to and from the adapter block;
a plurality of removable caps being in engagement with corners of said rectangular shape and being configured for exposing passages into said cover unit; and
a plurality of tabs being in engagement with said plurality of removable caps, said plurality of tabs being configured for holding a power cord of the power adapter wrapped about a periphery of said cover unit,

16. The apparatus as recited in claim 15, in which said plurality of tabs are configured to be further operable for supporting said cover unit in an upright position.

17. The apparatus as recited in claim 15, in which said cover unit further comprises two halves being configured to be removably joinable about the adapter block.

18. The apparatus as recited in claim 15, in which said plurality of ventilation openings comprise slots.

19. The apparatus as recited in claim 15, in which said cover unit further comprises a non-slip material.

20. The apparatus as recited in claim 15, further comprising a plurality of foot structures being disposed on at least a bottom side of said cover unit, said plurality of foot structures being configured for supporting said cover unit a distance above a flat surface.
